(19) United States
(12) Patent Application Publication
(10) Pub. No.: US 2019/0109871 A1
(43) Pub. Date: Apr. 11, 2019

(54) TECHNIQUES FOR COMPUTING AN OVERALL TRUST SCORE FOR A DOMAIN BASED UPON TRUST SCORES PROVIDED BY USERS

(71) Applicant: Facebook, Inc., Menlo Park, CA (US)

(72) Inventors: David Vickrey, Mountain View, CA (US); Alexander Calan Leavitt, San Francisco, CA (US); Anavil Tripathi, Newark, CA (US); Harsh Mayur Selani, Newark, CA (US); Prasoon Mishra, Mountain View, CA (US); Sara Lee Su, San Jose, CA (US); Grace Louise Jackson, Belmont, CA (US)

(21) Appl. No.: 15/729,528

(22) Filed: Oct. 10, 2017

(51) Int. Cl. H04L 29/06; G06F 7/02

(52) U.S. Cl. CPC H04L 63/1433; G06F 7/026

(57) ABSTRACT

The present disclosure relates to techniques for determining trustworthiness of a domain among users. The determination may be based upon trust scores provided by the users for the domain. When all users have specified a trust score for the domain, an overall trust score may be computed based upon the specified trust scores. When some users have not specified a trust score for the domain, trust scores may be computed for the users based upon the specified trust scores, and an overall trust score may be computed based upon the specified trust scores and the computed trust scores. Based on the overall trust score, a social networking system may send content to users of the social networking system.

### BACKGROUND

A social networking system (SNS) may enable its users to interact and share content with each other through various interfaces provided by the SNS. In some cases, the SNS may also identify content itself and then provide the identified content to its users. And while there are many ways to identify such content, social networking systems are always looking for better ways to identify the content and increase the likelihood that users will view the content.

### SUMMARY

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates to techniques for determining trustworthiness of a domain among users. The determination may be based upon trust scores provided by the users for the domain. For example, an overall trust score for a domain may be determined based upon survey responses provided by a set of users for the domain. A survey response may indicate (1) whether a user recognizes the domain; and (2) if the user recognizes the domain, a trust score (i.e., an amount that the user trusts the domain). The survey responses may be received in response to a survey sent to the users.

When all users have specified a trust score for a domain, the users may be ordered based upon ascending order of their respective trust scores. Then, a set of one or more users may be selected to be used to calculate an overall trust score for the domain. For example, the set of one or more users may be selected such that outliers are not included. The set of users may also be selected using a pessimistic approach (i.e., users are favored that have lower trust scores). In one illustrative example, the overall trust score may be calculated as an average of trust scores from the set of one or more users. If the overall trust score exceeds a threshold, the domain may be tagged as a trusted domain.

When some users have not specified a trust score for the domain, a trust score may be determined for the users that have not specified a trust score. In a simple example, a trust score may be determined to be the lowest or highest value possible of a trust score for the domain. In other examples, techniques for determining trust scores may be split between a non-clustering technique and a clustering technique.

The non-clustering technique may determine a trust score for a user based upon one or more users similar to the user. For example, each user in a population may be associated with a multi-dimensional vector, the dimensions of which are based upon the user's interactions (e.g., providing a link to a domain, selection of the link, sharing the link, liking the link, or otherwise interacting with the link) within a social networking system. In some examples, a vector for a user may be based upon domains that the user has had at least two interactions within the last 30 days. It should be recognized that the domains that the vector is based upon may or may not include the domain for which the trust score is being determined.

For each unspecified trust score, one or more other users that have specified trust scores may be identified based upon a distance between a vector for a user associated with the unspecified trust score and vectors for the one or more other user. For example, the closest one or more other users to the user may be identified. Specified trust scores of the one or more other users may then be used to determine a trust score for the user. After unspecified trust scores have been determined, an overall trust score may be determined for the domain similar to as described above (e.g., the users may be ordered, a set of the users may be selected, and an overall trust score may be calculated based upon trust scores for the domain for the set of the users).

The clustering technique may group users together based upon the user's interactions within a social networking system. The number of clusters may be user defined (e.g., 10). However, rather than having to identify a particular number of users that are similar to a user that did not provide a trust score for the domain as performed by the non-clustering technique, users within a cluster may be used to determine a trust score for the user. For example, an unspecified trust score may be determined to be an average of specified trust scores for each user within the cluster.

After trust scores are determined for the users that did not specify a trust score, the clustering technique may use either a user-based or cluster-based approach to determine an overall trust score for the domain. The user-based approach is similar to as described above (e.g., the users may be ordered, a set of the users may be selected, and an overall trust score may be calculated based upon trust scores for the domain for the set of the users). The cluster-based approach may order the clusters based upon average trust scores within a cluster. A set of clusters may then be selected to calculate an overall trust score for the domain. For example, the overall trust score may be calculated as an average of a cluster's trust score for each of the set of clusters. In some examples, the cluster-based approach may be used without determining trust scores for the users that did not specify a trust score. For example, the users that did not specify a trust score may be ignored. If the overall trust score exceeds a threshold, the domain may be tagged as a trusted domain.

When calculating an overall trust score, weighting, smoothing, or adding fake users may be used to account for recognition bias with user-specified trust scores. And based upon the overall trust score, a social networking system (SNS) may modify content to be sent to users of the SNS. For example, an indication may be associated with content from a trusted domain such that users may recognize that the domain from which the content is from is a trusted domain. For another example, content from a trusted domain may be sent to users instead of content from a domain that is not a trusted domain. For another example, content from a domain with a higher trust score may be sent to users instead of content from a domain with a lower trust score.

Various inventive embodiments are described herein, including methods, systems, non-transitory computer-readable storage media storing programs, code, or instructions executable by one or more processors, and the like, for event tracking. For example, a method may include presenting a survey to a user of a plurality of users, the survey including an option for the user to select a trust score from a set of trust scores for the domain. The method may further include receiving, for a domain, trust scores provided by a plurality of users, where a trust score provided by a user is indicative of a level of trust in the domain for the user. The trust scores may include the trust score selected by the user described above.

Based upon the trust scores, an overall trust score may be calculated for the domain. In some examples, calculating the overall trust score may include selecting a set of trust scores from the trust scores and calculating the overall trust score based upon trust scores included in the set of test scores. In such examples, the trust scores may include at least one trust score that is not included in the set of trust scores and each trust score of the set of trust scores may have a trust score less than an average of the trust scores. In some examples, selecting the set of trust users may include creating an ordered list of the trust scores and selecting the set of trust scores based upon an ordering of the ordered list. The ordering may be from lowest to highest, where at least one lowest trust score or at least one highest trust score in the ordered list is not selected to be in the set of trust scores.

Based upon the overall trust score, it may be determined to identify the domain as a trusted domain. In response to identifying the domain as a trusted domain, the domain may be tagged as a trusted domain in a social networking system (SNS). The method may further include sending content associated with the domain to a user of the SNS, where the content includes information indicating that the content is associated with a trusted domain. In addition to or in the alternative, the method may further include sending content associated with the domain to a user of the SNS based upon the domain being tagged as a trusted domain.

Another embodiment described herein comprises a method that includes presenting a survey to a user of a plurality of users, the survey including an option for the user to identify whether the user recognizes the domain and, if the user recognizes the domain, to select a trust score from a set of trust scores for the domain.

The method may further include generating a multi-dimensional vector for each user of the plurality of users based upon one or more interactions of the user within the SNS and generating clusters of one or more users from the plurality of users based upon multi-dimensional vectors for each user of the plurality of users. In some examples, the method may further include identifying one or more clusters of the clusters, the one or more clusters including at least one user that does not recognize the domain and for each cluster of the one or more clusters, identifying one or more users that do not recognize the domain and for each user of the one or more users, computing a trust score for the user based upon trust scores for one or more other users in the cluster. In other examples, the method may further include for each cluster of the clusters, calculating a cluster trust score for the domain based upon trust scores for users in the cluster, creating an ordered list of the clusters based upon the cluster trust scores, selecting a set of clusters from the clusters, and calculating the average trust score based upon cluster trust scores included in the set of clusters. In such examples, the clusters include at least one cluster that is not included in the set of clusters.

The method may further include receiving, for a domain, trust scores provided by a first set of users of the plurality of users, where a trust score provided by a user of the first set of users is indicative of a level of trust in the domain for the user. The method may further include computing a trust score for each user of a second set of users of the plurality of users and calculating an overall trust score for the domain based upon the trust scores provided by the first set of users and the trust scores computed for the second set of users. In some examples, computing the trust score for the user includes averaging a trust score for one or more users other than the user. In some examples, calculating the overall trust score may include selecting a set of users from the plurality of users and calculating the overall trust score based upon trust scores of the users included in the set of users. In such examples, the plurality of users may include at least one user that is not included in the set of users. Selecting the set of users may include creating an ordered list of the trust scores provided by the first set of users and the trust scores computed for the second set of users and selecting the set of trust scores based upon an ordering of the ordered list. The ordering may be from lowest to highest, where at least one lowest trust score or at least one highest trust score in the ordered list are not selected to be in the set of trust scores.

The method may further include determining to identify the domain as a trusted domain based upon the overall trust score and tagging the domain as a trusted domain in a social networking system (SNS). In some examples, the method may further include sending content associated with the domain to a user of the SNS, where the content includes information indicating that the content is associated with a trusted domain. In other examples, the method may further include sending content associated with the domain to a user of the social networking system based upon the domain being tagged as a trusted domain.

The foregoing, together with other features and embodiments will become more apparent upon referring to the following specification, claims, and accompanying drawings.

### BRIEF DESCRIPTION OF THE DRAWINGS

Illustrative embodiments are described in detail below with reference to the following figures.

FIG. 1 depicts a simplified flowchart of processing performed to tag a domain according to certain embodiments.

FIG. 2 depicts an example of a user survey according to certain embodiments.

FIG. 3 depicts a set of trust scores provided by users for a domain according to certain embodiments.

FIG. 4 depicts a simplified flowchart of processing performed to calculate an overall trust score for a domain according to certain embodiments.

FIG. 5 depicts steps for calculating an overall trust score for a domain according to certain embodiments.

FIG. 6 depicts a simplified flowchart of processing performed to tag a domain based upon at least one user that has not provided a trust score according to certain embodiments.

FIG. 7 depicts another example of a user survey according to certain embodiments.

FIG. 8 depicts a set of trust score responses provided by users for a domain according to certain embodiments.

FIG. 9 depicts a set of trust scores for a domain according to certain embodiments.

FIG. 10 depicts a simplified flowchart of processing performed to calculate an overall trust score for a domain based upon cluster trust scores according to certain embodiments.

FIG. 11A depicts a set of trust scores provided by users for a domain split into multiple clusters according to certain embodiments.

FIG. 11B depicts an overall trust score computed by selecting a set of clusters according to certain embodiments.

FIG. 12 depicts a simplified flowchart of processing performed to calculate an overall trust score for a domain when a trust score for a user has been calculated using clustering according to certain embodiments.

FIG. 13 depicts a set of trust score responses provided by users for a domain split into multiple clusters according to certain embodiments.

FIG. 14 depicts a set of trust scores for a domain split between multiple clusters according to certain embodiments.

FIG. 15 is a simplified block diagram of a distributed system according to certain embodiments.

FIG. 16 depicts an example of content included on a page provided by a social networking system according to certain embodiments.

FIG. 17 depicts a computer system that may be used to implement certain embodiments described herein.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates to techniques for determining trustworthiness of a domain among users. The determination may be based upon trust scores provided by the users for the domain. For example, an overall trust score for a domain may be determined based upon survey responses provided by a set of users for the domain. A survey response may indicate (1) whether a user recognizes the domain; and (2) if the user recognizes the domain, a trust score (i.e., an amount that the user trusts the domain). The survey responses may be received in response to a survey sent to the users.

When all users have specified a trust score for a domain, the users may be ordered based upon ascending order of their respective trust scores. Then, a set of one or more users may be selected to be used to calculate an overall trust score for the domain. For example, the set of one or more users may be selected such that outliers are not included. The set of users may also be selected using a pessimistic approach (i.e., users are favored that have lower trust scores). In one illustrative example, the overall trust score may be calculated as an average of trust scores from the set of one or more users. If the overall trust score exceeds a threshold, the domain may be tagged as a trusted domain.

When some users have not specified a trust score for the domain, a trust score may be determined for the users that have not specified a trust score. In a simple example, a trust score may be determined to be the lowest or highest value possible of a trust score for the domain. In other examples, techniques for determining trust scores may be split between a non-clustering technique and a clustering technique.

The non-clustering technique may determine a trust score for a user based upon one or more users similar to the user. For example, each user in a population may be associated with a multi-dimensional vector, the dimensions of which are based upon the user's interactions (e.g., providing a link to a domain, selection of the link, sharing the link, liking the link, or otherwise interacting with the link) within a social networking system. In some examples, a vector for a user may be based upon domains that the user has had at least two interactions within the last 30 days. It should be recognized that the domains that the vector is based upon may or may not include the domain for which the trust score is being determined.

For each unspecified trust score, one or more other users that have specified trust scores may be identified based upon a distance between a vector for a user associated with the unspecified trust score and vectors for the one or more other users. For example, the closest one or more other users to the user may be identified. Specified trust scores of the one or more other users may then be used to determine a trust score for the user. After unspecified trust scores have been determined, an overall trust score may be determined for the domain similar to as described above (e.g., the users may be ordered, a set of the users may be selected, and an overall trust score may be calculated based upon trust scores for the domain for the set of the users).

The clustering technique may group users together based upon the user's interactions within a social networking system. The number of clusters may be user defined (e.g., 10). However, rather than having to identify a particular number of users that are similar to a user that did not provide a trust score for the domain as performed by the non-clustering technique, users within a cluster may be used to determine a trust score for the user. For example, an unspecified trust score may be determined to be an average of specified trust scores for each user within the cluster.

After trust scores are determined for the users that did not specify a trust score, the clustering technique may use either a user-based or cluster-based approach to determine an overall trust score for the domain. The user-based approach is similar to as described above (e.g., the users may be ordered, a set of the users may be selected, and an overall trust score may be calculated based upon trust scores for the domain for the set of the users). The cluster-based approach may order the clusters based upon average trust scores within a cluster. A set of clusters may then be selected to calculate an overall trust score for the domain. For example, the overall trust score may be calculated as an average of a cluster's trust score for each of the set of clusters. In some examples, the cluster-based approach may be used without determining trust scores for the users that did not specify a trust score. For example, the users that did not specify a trust score may be ignored. If the overall trust score exceeds a threshold, the domain may be tagged as a trusted domain.

When calculating an overall trust score, weighting, smoothing, or adding fake users may be used to account for recognition bias with user-specified trust scores. And based upon the overall trust score, a social networking system (SNS) may modify content to be sent to users of the SNS. For example, an indication may be associated with content from a trusted domain such that users may recognize that the domain from which the content is from is a trusted domain. For another example, content from a trusted domain may be sent to users instead of content from a domain that is not a trusted domain. For another example, content from a domain with a higher trust score may be sent to users instead of content from a domain with a lower trust score.

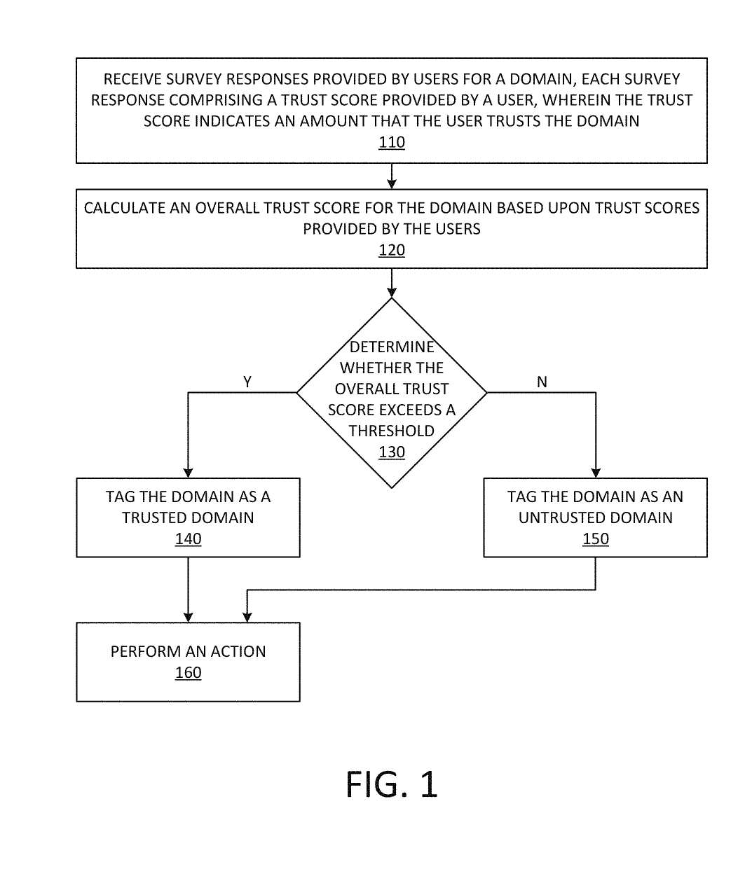

FIG. 1 depicts a simplified flowchart of processing performed to tag a domain according to certain embodiments. The processing depicted in FIG. 1 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 1 and described below is intended to be illustrative and non-limiting. Although FIG. 1 depicts the various processing steps occurring in a particular sequence or order, this is not intended to be limiting. In certain embodiments, the steps may be performed in some different order or some steps may also be performed in parallel. In one illustrative example, the processing depicted in FIG. 1 is performed by a social networking system (SNS). However, it should be recognized that some steps may be performed by a server remote from the SNS.

In the embodiment depicted in FIG. 1, the processing may be triggered at 110 when survey responses are received. The survey responses may be provided by users for the domain. While the survey responses may be received as the users provide the survey responses, the survey responses may also be received at some time after the users provide the survey responses. Each survey response may comprise a trust score provided by a user. The trust score may indicate an amount that the user trusts the domain. In other embodiments, instead of survey responses, trust scores that are each associated with a user may be received.

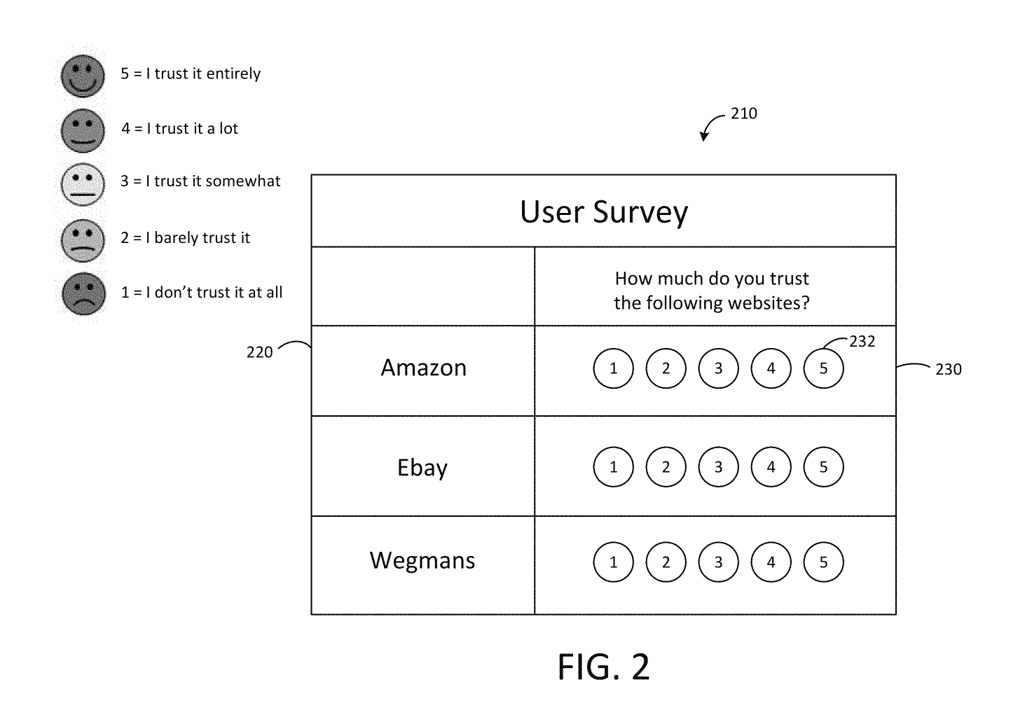

FIG. 2 depicts an example of user survey 210 according to certain embodiments. User survey 210 may be presented to a user so that the user may indicate an amount that the user trusts a particular domain. An example of a domain is illustrated at reference 220 (i.e., “Amazon). Other examples of domains include “Ebay” and “Wegmans.”

For one or more domains included in user survey 210, the user may indicate an amount that the user trusts a domain by selecting a level of trust at reference 230. For example, the user may select user-selectable button 232 to indicate that the user trust “Amazon” entirely. Other examples of an amount of trust include: “trust a lot,” “trust it somewhat,” “barely trust it,” and “don't trust it at all.” However, it should be recognized that an amount of trust may be indicated in other manners (e.g., more or less rating levels).

In some embodiments, domains included in user survey 210 may be selected at random. In other embodiments, user survey 210 may be adaptive (sometimes referred to as dynamic) so that domains with less data (e.g., generally or from a particular cluster) are prioritized when sending user survey 210 to users. For example, a first domain may be recognized by several users from a first cluster but few users from a second cluster. In such an example, user surveys sent to users in the second cluster may include the first domain while user surveys sent to users in the first cluster may not include the first domain.

Referring back to FIG. 1, at 120, an overall trust score may be calculated for the domain based upon the trust scores provided by users in 110. Calculating the overall trust score may include taking an average of the trust scores. While calculating an average is described here, it should be recognized that other summary statistics may be used, such as a median or a mode.

At 130, it may be determined whether the overall trust score exceeds a threshold. While a single threshold may be used for all domains, a different threshold may be defined for different domains. In some examples, the threshold may be based upon a number of trust scores used to calculate the overall trust score. For example, if more trust scores are used in the calculation, the threshold may be less. In other examples, the threshold may be based upon a number of users that indicated that they do not recognize a domain. In such examples, the threshold may be required to be higher if there are several users that do not recognize the domain. In other examples, the threshold may be based upon a number of users in a social networking system (SNS) that requested content from the domain. For example, if more users have requested content from the domain, the threshold may be lower.

At 140, if the overall trust score exceeds the threshold, the domain may be tagged as a trusted domain in the SNS. In the alternative, at 150, if the overall trust score does not exceed the threshold, the domain may be tagged as a untrusted domain in the SNS. Tagging the domain may include associating the domain with an indication that the domain is either trusted or untrusted. Tagging the domain may also include inserting an identification of the domain into a list of either trusted or untrusted domains. Such a list may be stored by the SNS. In some embodiments, tagging a domain may include associating a trust score corresponding to the domain with the domain.

At 160, one or more actions may be performed. For example, by being tagged as a trusted domain, content from the domain may be identified and delivered to users of the SNS instead of content from a domain that is tagged as an untrusted domain. For another example, content from a domain with a higher trust score may be sent to users instead of content from a domain with a lower trust score. In addition to or in the alternative, tagging the domain may cause an indication to be inserted into content from the domain when the content is presented to users of the SNS. The indication may inform users that the content is either from a trusted or untrusted domain.

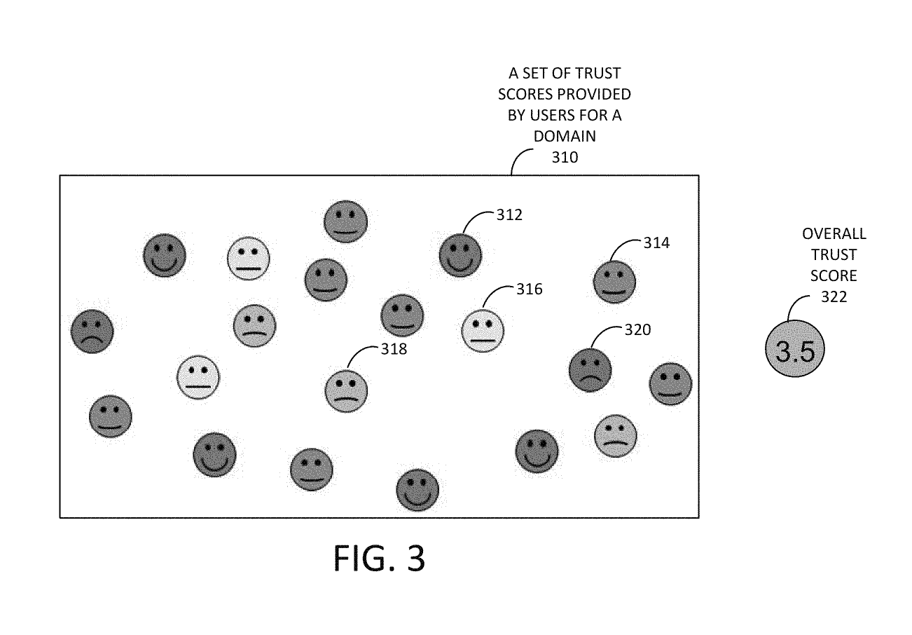

FIG. 3 depicts set of trust scores 310, which may be provided by users for a domain, according to certain embodiments. Each trust score of set of trust scores 310 may be provided by a different user. Each trust score is illustrated as a face, each face indicating a different trust score (as described in FIG. 2). For example, face 312 indicates that a user trusts the domain entirely, face 314 indicates that the user trusts the domain a lot, face 316 indicates that the user trusts the domain somewhat, face 318 indicates that the user barely trusts the domain, and face 320 indicates that the user does not trust the domain at all.

An overall trust score for set of trust scores 310 may be computed by averaging each trust score of set of trust scores 310. For example, the overall trust score for set of trust scores 310 is 3.5 (as indicated by reference 322). While calculating an average is described here, it should be recognized that other summary statistics may be used, such as a median or a mode.

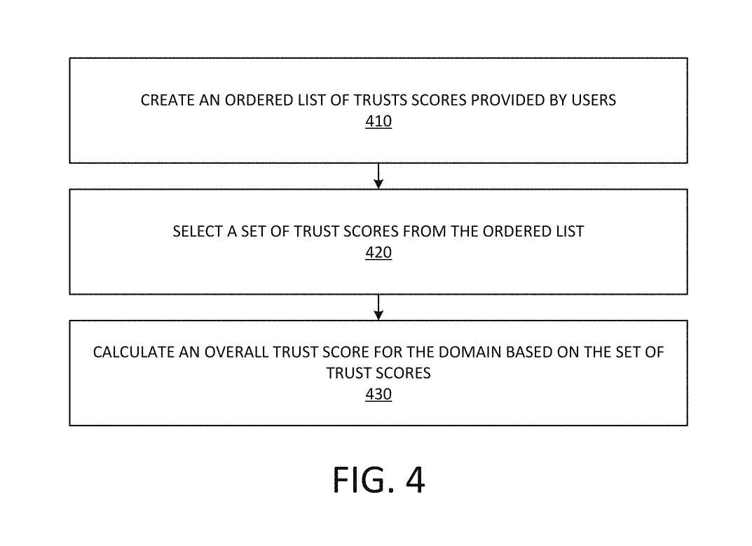

FIG. 4 depicts a simplified flowchart of processing performed to calculate an overall trust score for a domain according to certain embodiments. The processing depicted in FIG. 4 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain embodiments, the steps may be performed in some different order or some steps may also be performed in parallel. In one illustrative example, the processing depicted in FIG. 4 is performed by a social networking system (SNS). However, it should be recognized that some steps may be performed by a server remote from the SNS.

In the embodiment depicted in FIG. 4, the processing may be triggered at 410 when an ordered list of trusts scores is created. The trust scores may have been provided by users in response to user surveys as illustrated in FIG. 2 and discussed at 110 in FIG. 1. The ordered list may be in numerical order (i.e., highest to lowest). For example, a first trust score for the domain may be 2, a second trust score for the domain may be 4, and a third trust score for the domain may be 3. In such an example, the ordered list may be the first trust score, the third trust score, and the second trust score.

At 420, a set of trust scores may be selected from the ordered list. The trust scores may include at least one trust score that is not included in the set of trust scores. For example, the first trust score may be not included in the set of trust scores, leaving the second and third trust score in the set of trust scores.

In some examples, the set of trust scores are selected based upon removing outliers. In other examples, one or more most negative trust scores (e.g., the lowest 25%) and one or more most positive trust scores (e.g., the highest 25%) may be removed. In addition, one or more more-positive trust scores (e.g., 50%-75%) may be removed. In such examples, the set of trust scores may be trust scores from 25%-50%, sometimes referred to as a pessimistic strategy. The pessimistic strategy removes potential outliers and favors negative trust scores over positive trust scores (i.e., each trust score of the set of trust scores has a trust score less than an average of the trust scores).

At 430, an overall trust score may be calculated for the domain based upon the set of trust scores. For example, an average may be computed for the set of trust scores. Based on the example above, an overall trust score may be 2.5 (i.e., (2+3)/2). While calculating an average is described here, it should be recognized that other summary statistics may be used, such as a median or a mode.

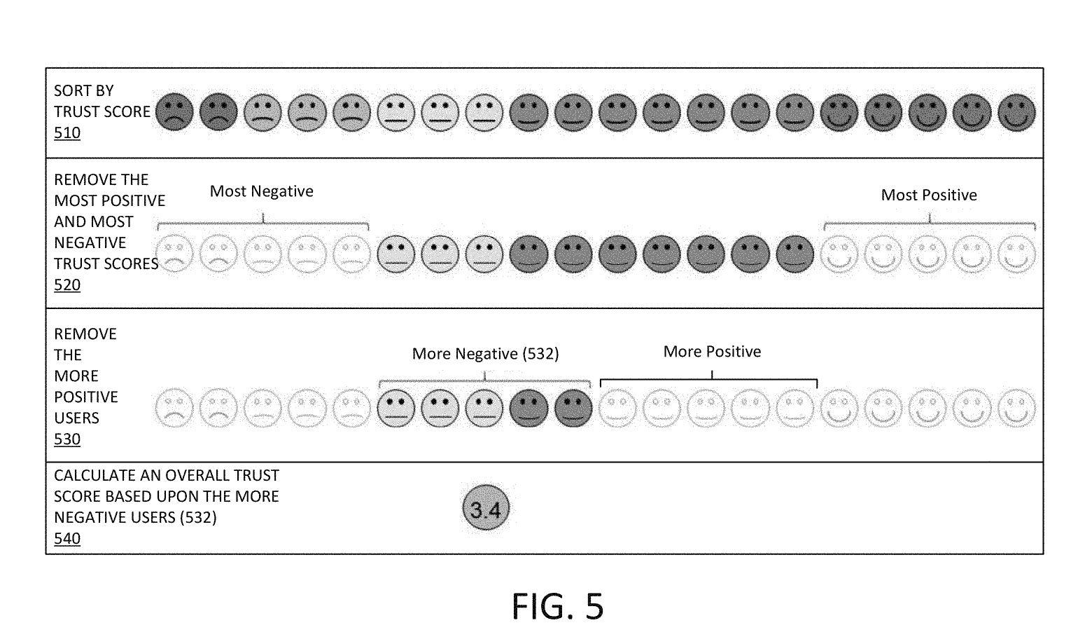

FIG. 5 depicts steps for calculating an overall trust score for a domain according to certain embodiments. The first step (510) may include sorting trust scores from lowest to highest. The next step may be to remove the most positive and the most negative trust scores. After the most positive and the most negative trust scores are removed, the more positive trust scores may also be removed (530). By removing the more positive trust scores, the more negative trust scores (532) may remain in a set of trust scores. A final step may include calculating an overall trust score based upon the more negative users. In the example illustrated in FIG. 5, the overall trust score may be 3.4 (i.e., (3+3+3+4+4)/5).

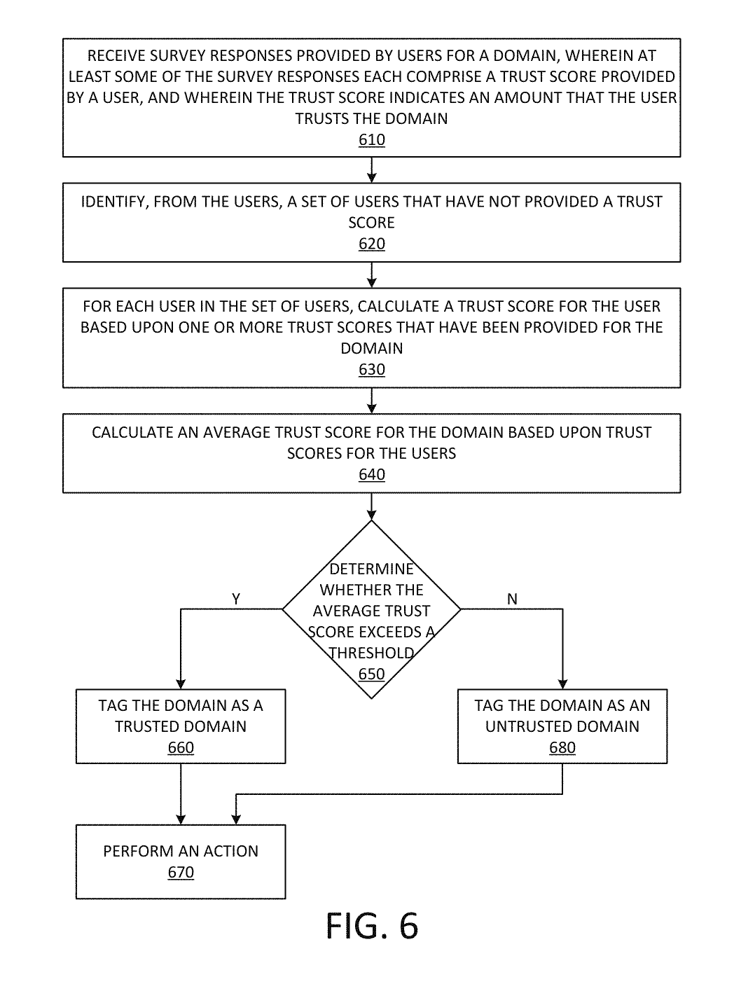

FIG. 6 depicts a simplified flowchart of processing performed to tag a domain based upon at least one user that has not provided a trust score according to certain embodiments. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 6 and described below is intended to be illustrative and non-limiting. Although FIG. 6 depicts the various processing steps occurring in a particular sequence or order, this is not intended to be limiting. In certain embodiments, the steps may be performed in some different order or some steps may also be performed in parallel. In one illustrative example, the processing depicted in FIG. 6 is performed by a social networking system (SNS). However, it should be recognized that some steps may be performed by a server remote from the SNS.

In the embodiment depicted in FIG. 6, the processing may be triggered at 610 when survey responses are received. The survey responses may be provided by users for a domain. While the survey responses may be received as the users provide the survey responses, the survey responses may also be received at some time after the users provide the survey responses. A survey response may comprise a trust score provided by a user. The trust score may indicate an amount that the user trusts the domain. Some survey responses may not include a trust score for the domain. Such survey responses may indicate that the user does not recognize the domain. In other embodiments, instead of survey responses, trust scores may be received. In such embodiments, one or more users may have not provided trusts scores for the domain. Accordingly, one or more unspecified trust scores may be added to the trust scores to indicate that the one or more unspecified trust scores need to be determined.

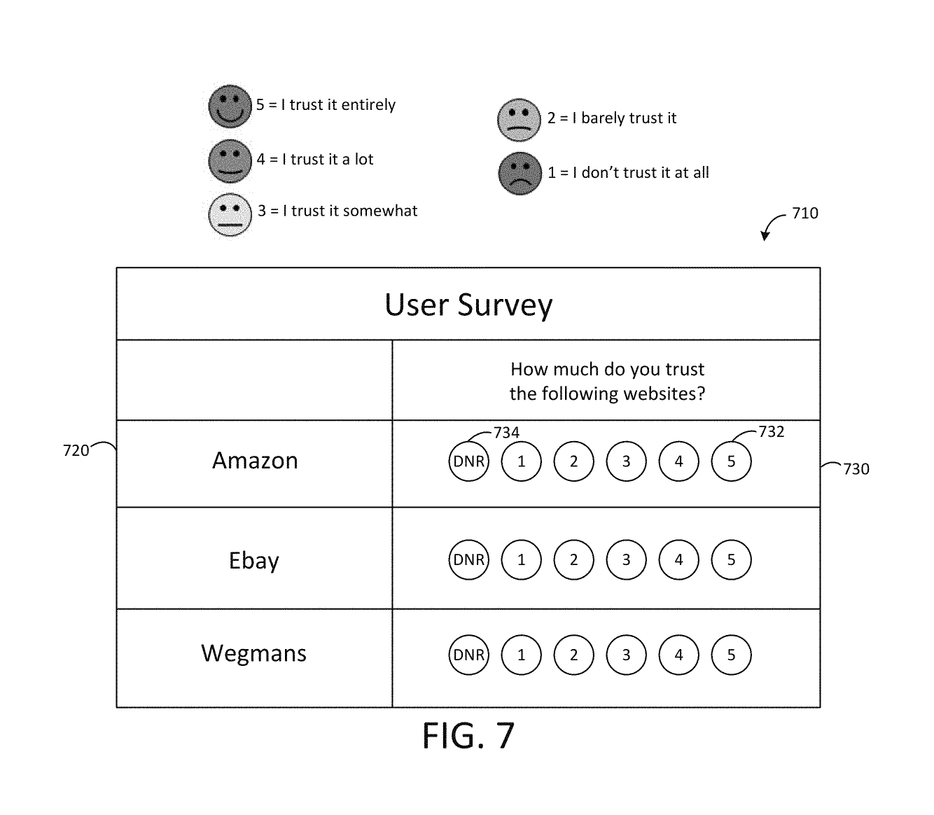

FIG. 7 depicts an example of user survey 710 according to certain embodiments. User survey 710 may be presented to a user so that the user may indicate an amount that the user trusts a particular domain. An example of a domain is illustrated at reference 720 (i.e., “Amazon). Other examples of domains include “Ebay” and “Wegmans.”

For one or more domains included in user survey 710, the user may indicate an amount that the user trusts a domain by selecting a level of trust at reference 730. For example, the user may select user-selectable button 732 to indicate that the user trusts a domain entirely (e.g., “Amazon”). Other examples of an amount of trust include: “trust a lot,” “trust it somewhat,” “barely trust it,” and “don't trust it at all.” However, it should be recognized that an amount of trust may be indicated in other manners (e.g., more or less rating levels). Reference 730 may also include user-selectable button 734 to indicate that the user does not recognize (sometimes referred to as DNR) a domain (e.g., “Amazon”). In some examples, rather than having user survey 710 include user-selectable button 734, user survey 710 may include a first page that asks whether a user recognizes one or more domains and a second page that asks for a trust score for each of the one or more domains that the user indicated that they recognize (not illustrated). In some embodiments, user survey 710 may be adaptive so that domains with less data (e.g., generally or from a particular cluster) are prioritized when sending user survey 710 to users.

Referring back to FIG. 6, at 620, a set of users may be identified from the users. The set of users may be those that have not provided a trust score. For example, the set of users may correspond to those one or more unspecified trust scores.

At 630, a trust score may be calculated for each user in the set of users based upon one or more trust scores that have been provided for the domain. For example, an average may be calculated for every trust score provided for the domain. The trust score for each user in the set of users may be set as the average. For another example, an average may be calculated for a subset of the trust scores provided for the domain. Similar to as described above for FIGS. 4 and 5, the subset may remove outliers and/or more positive trust scores. For another example, an average may be calculated for a particular number of trust scores that are associated with users that are similar to the user that is associated with the unspecified trust score. While calculating an average is described here, it should be recognized that other summary statistics may be used, such as a median or a mode.

At 640, an overall trust score may be calculated for the domain based upon trust scores for the users (e.g., the provided trust scores and the calculated trust scores). Except for 640 including the calculated trust scores), the step may be similar to that as described above in FIG. 1 at 130. The remaining steps illustrated in FIG. 6 (i.e., 660, 670, 680, and 690) may be performed similar to as described above in FIG. 1 (i.e., 140, 150, 160, and 170, respectively).

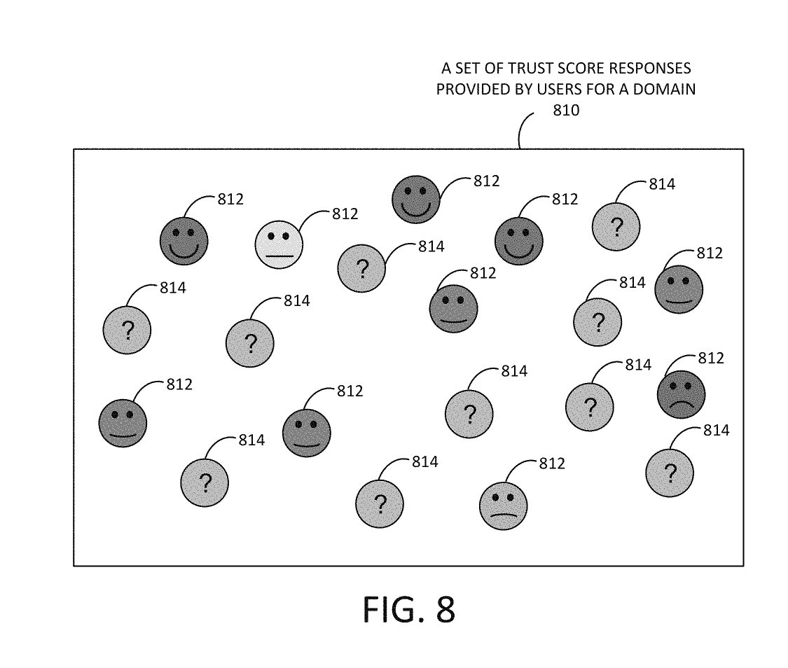

FIG. 8 depicts set of trust score responses 810 provided by users for a domain according to certain embodiments. Set of trust score responses 810 may include one or more specified trust scores (e.g., references 812) and one or more unspecified trust scores (e.g., references 814). Each of the one or more specified trust scores and the one or more unspecified trust scores may be provided by a different user in response to a user survey, as depicted in FIG. 7. The one or more unspecified trust scores may be those in which a user did not recognize the domain. In FIG. 7, an unspecified trust score is indicated by either selecting user-selectable button 734 or not selecting any user-selectable button for the domain. In FIG. 8, each specified trust score is illustrated as a face, each face indicating a different trust score (as described in FIGS. 2 and 3).

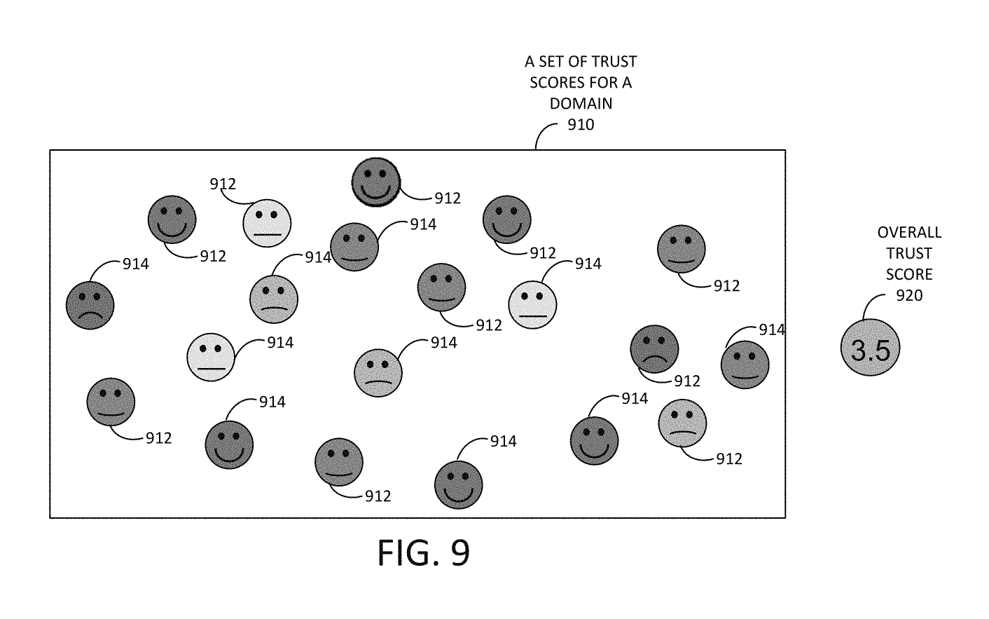

FIG. 9 depicts set of trust scores 910 for a domain according to certain embodiments. Set of trust scores 910 may be a result of calculating the unspecified trust scores from FIG. 8. In particular, set of trust scores 910 may include one or more trust scores that are provided by a user in response to a user survey and one or more trust scores that are calculated, as described at 630 in FIG. 6. An overall trust score may be computed by averaging each trust score of set of trust scores 910. For example, the overall trust score for set of trust scores 910 is 3.5 (as indicated by reference 920). While calculating an average is described here, it should be recognized that other summary statistics may be used, such as a median or a mode.

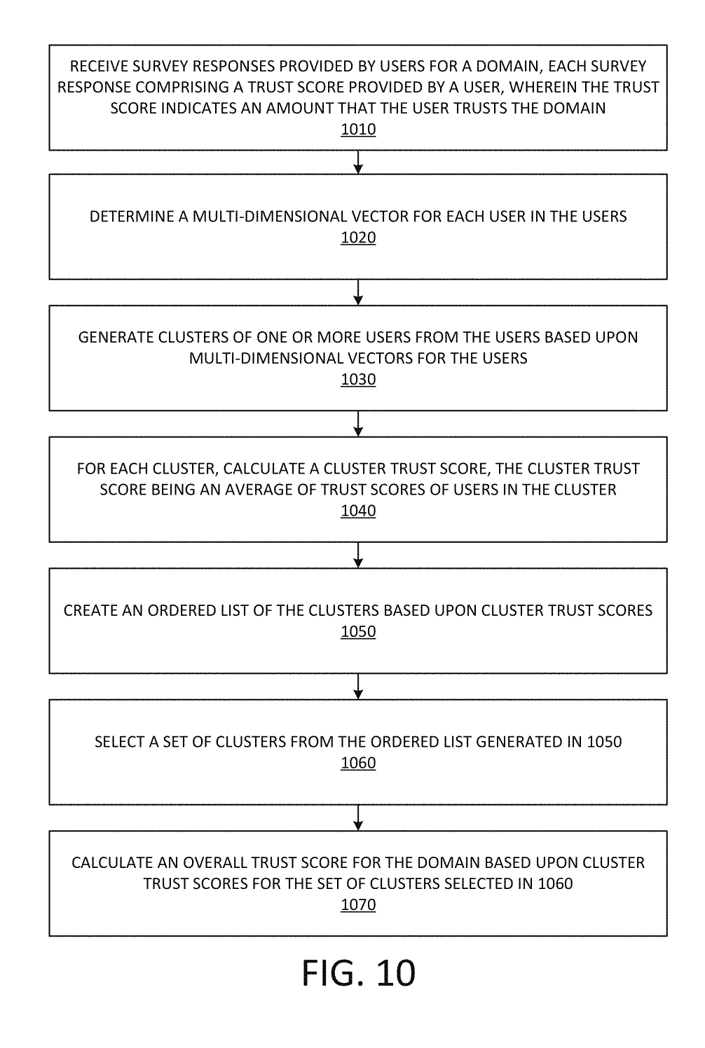

FIG. 10 depicts a simplified flowchart of processing performed to calculate an overall trust score for a domain based upon cluster trust scores according to certain embodiments. The processing depicted in FIG. 10 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 10 and described below is intended to be illustrative and non-limiting. Although FIG. 10 depicts the various processing steps occurring in a particular sequence or order, this is not intended to be limiting. In certain embodiments, the steps may be performed in some different order or some steps may also be performed in parallel. In one illustrative example, the processing depicted in FIG. 10 is performed by a social networking system (SNS). However, it should be recognized that some steps may be performed by a server remote from the SNS.

In the embodiment depicted in FIG. 10, the processing may be triggered at 1010 when survey responses are received. The survey responses may be provided by users of a social networking system (SNS). While the survey responses may be received as the users provide the survey responses, the survey responses may also be received at some time after the users provide the survey responses. Each survey response may comprise a trust score for a domain provided by a user. The trust score may indicate an amount that the user trusts the domain. Some survey responses may not include a trust score for the domain. Such survey responses may indicate that the user does not recognize the domain. In other embodiments, instead of survey responses, trust scores may be received. In such embodiments, one or more users may have not provided trusts scores for the domain. Accordingly, one or more unspecified trust scores may be added to the trust scores to indicate that the one or more unspecified trust scores need to be calculated.

In some examples, the users may be split into clusters, where each cluster includes one or more users. To split the users into clusters, the users may be embed in a vector space so that distances between the users in the vector space may be more easily approximated. By splitting the users into clusters, one or more particular clusters may be excluded from overall trust score calculations. In some examples, a cluster may include one or more users with unspecified trust scores. The one or more users may be those that indicated that they do not recognize the domain. In other examples, all users may have specified a trust score. This process is described in 1020-1070.

At 1020, a multi-dimensional vector may be determined for each user in the users. In some examples, the multi-dimensional vector may be determined by selecting one or more attributes associated with a user and computing weights for each attribute. In such examples, the multi-dimensional vector may be equal to aw₁+bw₂+cw₃, where a, b, and c are attributes and w₁, w₂, and w₃ are weights. Dimensions of the multi-dimensional vector (e.g., number of attributes) may be based upon information regarding the user known by the SNS. For example, the SNS may include a social graph that indicates connections between users within the SNS. The social graph may be used to determine the multi-dimensional vector. For another example, the SNS may also store interactions that a user performs within the SNS. Examples of interactions may include “liking” content that is shared by the SNS, following a particular page that is hosted by the SNS, viewing content via the SNS, or the like. In one illustrative example, when based on interactions, an attribute may be associated with a domain and a weight for the attribute may be associated with whether the user has interacted with content from the domain at least a minimum number of times.

At 1030, clusters of one or more users may be generated from the users based upon multi-dimensional vectors for the users. For example, the one or more users may be included in a cluster when the one or more users are similar to each other based upon multi-dimensional vectors of the one or more users. A person of ordinary skill in the art should recognize how to cluster users represented by multi-dimensional vectors.

At 1040, a cluster trust score may be generated for each cluster. The cluster trust score may be calculated by taking an average of trust scores of users in a cluster. When there are some users that have not specified a trust score in a cluster, a cluster trust score for the cluster may be calculated by ignoring the users that have not specified a trust score. While calculating an average is described here, it should be recognized that other summary statistics may be used, such as a median or a mode.

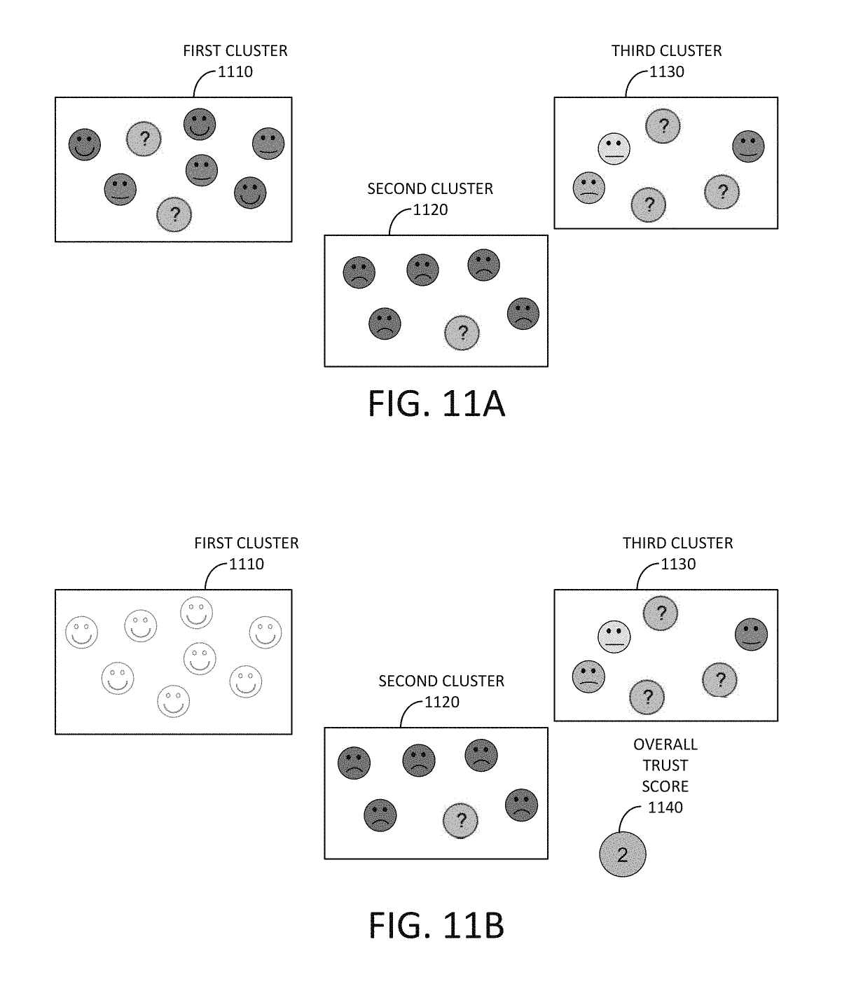

At 1050, an ordered list may be created of the clusters based upon cluster trust scores. For example, the cluster trust scores may be ordered from lowest to highest. FIG. 11A depicts a set of trust scores provided by users for a domain split into multiple clusters according to certain embodiments.

At 1060, a set of clusters may be selected from the ordered list generated in 1050. For example, one or more clusters may be left out of the set of clusters, as illustrated in FIG. 11B. In particular, FIG. 11B depicts an overall trust score computed by selecting a set of clusters according to certain embodiments. In FIG. 11B, first cluster 1110 is excluded from the set of clusters. In other words, the set of clusters includes second cluster 1120 and third cluster 1130. Similar to as described above for users, first cluster 1120 may have been removed because first cluster 1110 includes the highest cluster trust score. However, as described herein, it should be recognized that particular clusters (like users) may be removed based upon a different determination.

At 1070, an overall trust score is calculated for the domain based upon cluster trust scores for the set of clusters selected in 1060. The overall trust score may be an average of the cluster trust scores for the set of clusters selected in 1060. In FIG. 11B, the overall trust score is 2 (i.e., (1+3)/2). While calculating an average is described here, it should be recognized that other summary statistics may be used, such as a median or a mode.

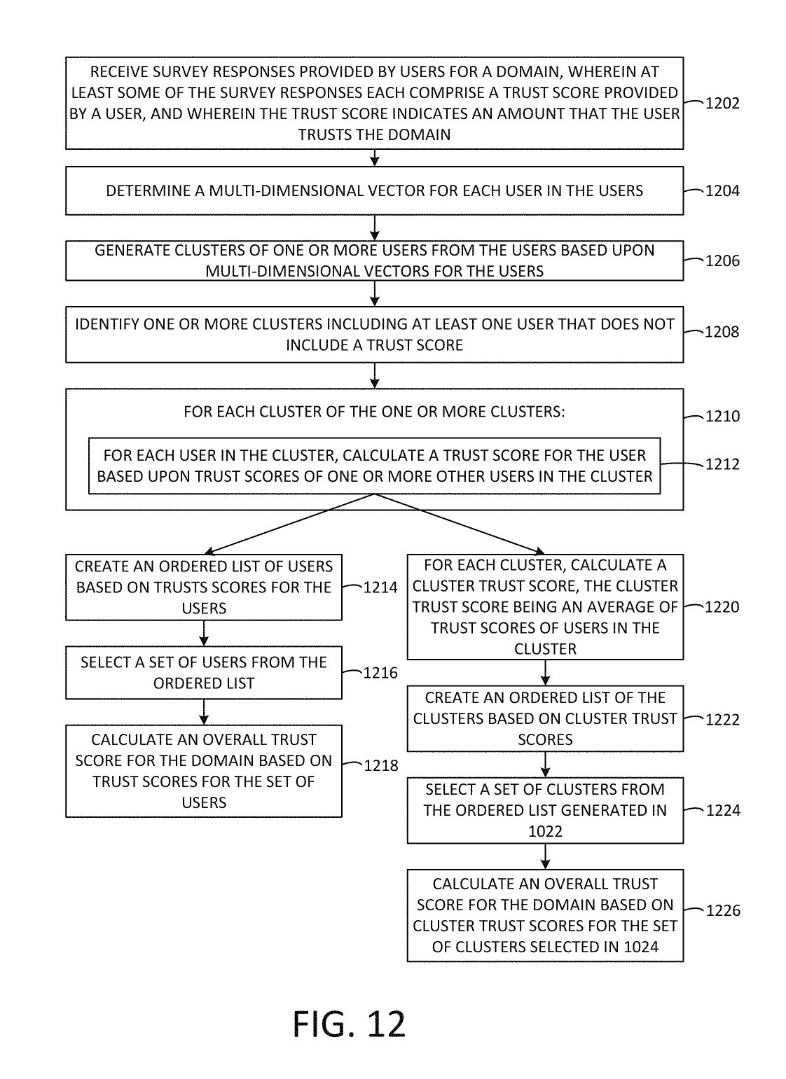

FIG. 12 depicts a simplified flowchart of processing performed to calculate an overall trust score for a domain when a trust score for a user has been calculated using clustering according to certain embodiments. The processing depicted in FIG. 12 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 12 and described below is intended to be illustrative and non-limiting. Although FIG. 12 depicts the various processing steps occurring in a particular sequence or order, this is not intended to be limiting. In certain embodiments, the steps may be performed in some different order or some steps may also be performed in parallel. In one illustrative example, the processing depicted in FIG. 12 is performed by a social networking system (SNS). However, it should be recognized that some steps may be performed by a server remote from the SNS.

In the embodiment depicted in FIG. 12, the processing may be triggered at 1202 when survey responses are received. The survey responses may be provided by users of a social networking system. While the survey responses may be received as the users provide the survey responses, the survey responses may also be received at some time after the users provide the survey responses. Each survey response may comprise a trust score for a domain provided by a different user. The trust score may indicate an amount that the user trusts the domain. Some survey responses may not include a trust score for the domain. Such survey responses may indicate that the user does not recognize the domain. In other embodiments, instead of survey responses, trust scores may be received. In such embodiments, one or more users may have not provided trusts scores for the domain. Accordingly, one or more unspecified trust scores may be added to the trust scores to indicate that the one or more unspecified trust scores need to be calculated.

Calculating an unspecified trust score for a user may be based upon specified trust scores for one or more other users. To determine which one or more others users to use for the calculation, the users may be embed in a vector space so that distances between the users in the vector space approximate a similarity between the users, such as described for 1204. At 1204, a multi-dimensional vector may be determined for each user in the users, similar to as described in FIG. 10 at 1020. In addition, at 1206, clusters of one or more users may generated from the users based upon multi-dimensional vectors for the users, similar to as described in FIG. 10 at 1030. At 1208, one or more clusters may be identified from the clusters, the one or more clusters including at least one user that does not include a trust score.

At 1210 and 1212, a loop through each user in each cluster of the one or more clusters may occur. For example, for each cluster of the one or more clusters, a trust score may be calculated for each user in the cluster based upon trust scores of one or more other users in the cluster, as described herein.

After the trust scores are calculated, an overall trust score may be calculated in a variety of ways. For example, at 1214, 1216, and 1218, the overall trust score may be calculated similar to 410, 420, and 430 of FIG. 4. In the alternative, at 1220, 1222, 1224, and 1226, the overall trust score may be calculated similar to 1040, 1050, 1060, and 1070 of FIG. 10. When the overall trust score is calculated according to 1220, 1222, 1224, and 1226, trust scores may not be calculated for users that did not specify a trust score. Instead, the users that did not specify a trust score may be ignored when calculating the overall trust score.

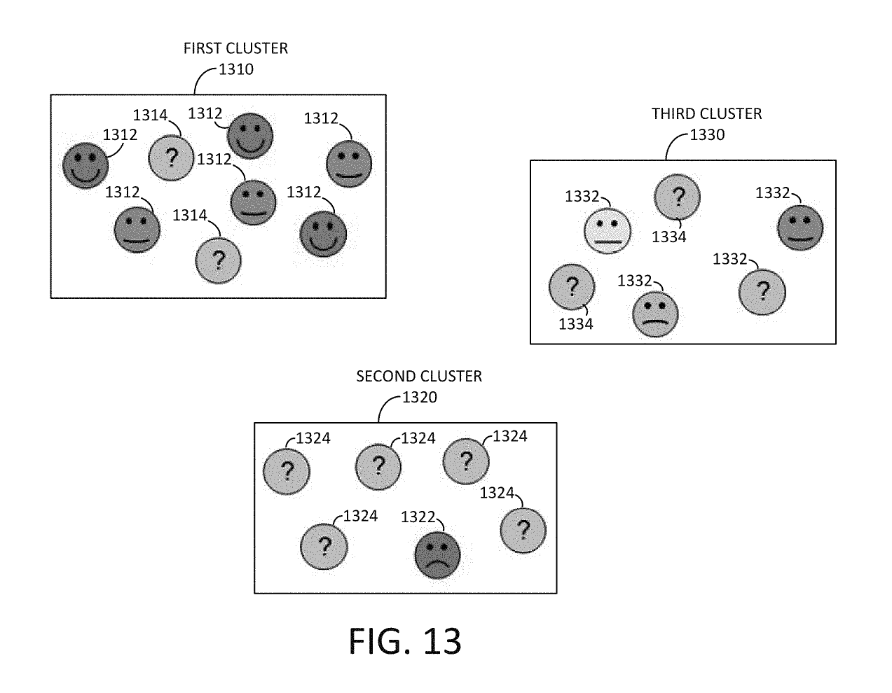

FIG. 13 depicts a set of trust score responses provided by users for a domain split into multiple clusters according to certain embodiments. The clusters include first cluster 1310, second cluster 1320, and third cluster 1330. Each cluster includes zero or more specified trust scores (e.g., reference 1312 in first cluster 1310, reference 1322 in second cluster 1320, and reference 1332 in third cluster 1330) and zero or more unspecified trust scores (e.g., reference 1314 in first cluster 1310, reference 1324 in second cluster 1320, and reference 1334 in third cluster 1330). Each of the specified trust scores and the unspecified trust scores may be provided by a user in response to a user survey, as depicted in FIG. 7. The unspecified trust scores may be those in which a user did not recognize the domain. In FIG. 7, an unspecified trust score is indicated by either selecting user-selectable button 734 or not selecting any user-selectable button for the domain. In FIG. 13, each specified trust score is illustrated as a face, each face indicating a different trust score (as described in FIG. 7).

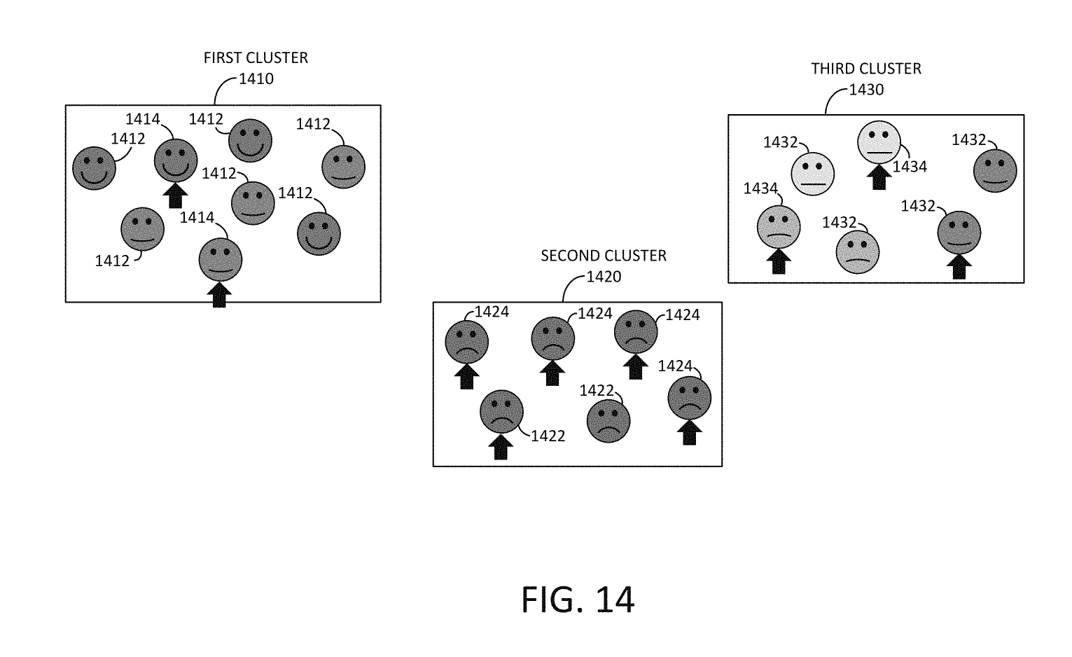

FIG. 14 depicts a set of trust scores for a domain split between multiple clusters according to certain embodiments. The set of trust scores depicted in FIG. 14 may be a result of calculating the unspecified trust scores from FIG. 13. In particular, the set of trust scores may include one or more trust scores that are provided by a user in response to a user survey and one or more trust scores that are calculated, as described at 1212 in FIG. 12 and further described below.

An unspecified trust score in a cluster may be associated with a user that did not provide a trust score in response to the user survey. The cluster may include one or more specified trust scores. In some examples, to calculate the unspecified trust score, the one or more specified trust scores may be averaged to generate an average trust score for the cluster. When the cluster includes multiple unspecified trust scores, each of the unspecified trust scores may be replaced with the average trust score (not illustrated in FIG. 14). While calculating an average is described here, it should be recognized that other summary statistics may be used, such as a median or a mode.

In other examples, the unspecified trust score may be replaced with a specified trust score in the cluster. In such examples, the replacements may be such that a proportion of particular trust scores is maintained (as illustrated in FIG. 14). For example, first cluster 1310 in FIG. 13 has two unspecified trust scores (i.e., references 1314). First cluster 1310 also includes three users with a trust score of 5 and three users with a trust score of 4. Accordingly, one of the unspecified trust scores may be replaced with a 5 and the other unspecified trust score may be replaced with a 4 in FIG. 14. Similarly, second cluster 1320 includes five unspecified trust scores and one specified trust score. The five unspecified trust scores may be replaced with the specified trust score (i.e., 1) in FIG. 14. Also similarly, third cluster 1330 may include three unspecified trust scores and three specified trust scores (i.e., a 2, a 3, and a 4). Accordingly, to keep the proportion of specified trust scores, a first unspecified trust score may be replaced with a 2, a second unspecified trust score may be replaced with a 3, and a third unspecified trust score may be replaced with a 4.

In some examples, a specified trust score associated with a closest user in a cluster to a user associated with an unspecified trust score may be used to replace the unspecified trust score. For example, if a cluster includes two specified trust scores and a single unspecified trust score, the unspecified trust score may be replaced with which ever specified trust score is associated with a user that is closest to a user associated with the unspecified trust score. The closeness may be based upon multi-dimensional vectors associated with the users, as described above.

After unspecified trust scores are calculated for the domain, an overall trust score may be computed for the domain. The overall trust score may be calculated based upon steps described in FIG. 12 (i.e., 1214-1218 or 1220-1226). While calculating an average is described here, it should be recognized that other summary statistics may be used, such as a median or a mode.

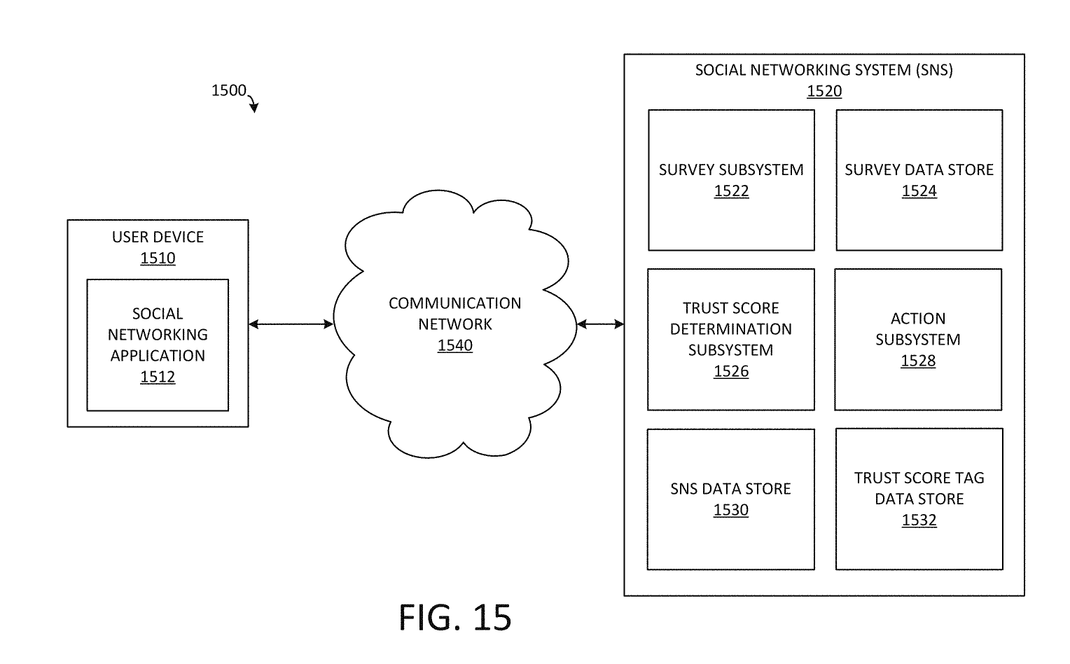

FIG. 15 is a simplified block diagram of distributed system 1500 according to certain embodiments. Distributed system 1500 may include one or more systems, including social networking system (SNS) 1520, communicatively coupled with one or more user devices (e.g., user device 1510).

In certain embodiments, the one or more user devices may be communicatively coupled with SNS 1520 via one or more communication networks (e.g., communication network 1540). Examples of communication networks include, without restriction, the Internet, a wide area network (WAN), a local area network (LAN), an Ethernet network, wireless wide-area networks (WWANs), wireless local area networks (WLANs), wireless personal area networks (WPANs), a public or private network, a wired network, a wireless network, and the like, and combinations thereof. Different communication protocols may be used to facilitate communications including both wired and wireless protocols such as IEEE 802.XX suite of protocols, TCP/IP, IPX, SAN, AppleTalk®, Bluetooth®, InfiniBand, RoCE, Fiber Channel, Ethernet, User Datagram Protocol (UDP), Asynchronous Transfer Mode (ATM), token ring, frame relay, High Level Data Link Control (HDLC), Fiber Distributed Data Interface (FDDI), and/or Point-to-Point Protocol (PPP), and others. A WWAN may be a network using an air interface technology, such as, a code division multiple access (CDMA) network, a Time Division Multiple Access (TDMA) network, a Frequency Division Multiple Access (FDMA) network, an OFDMA network, a Single-Carrier Frequency Division Multiple Access (SC-FDMA) network, a WiMax (IEEE 802.16), and so on. A WLAN may include an IEEE 802.11x network (e.g., a Wi-Fi network). A WPAN may be a Bluetooth network, an IEEE 802.15x, or some other types of network.

SNS 1520 may enable its users to interact with and share information with each other through various interfaces provided by SNS 1520. To use SNS 1520, a user typically has to register with SNS 1520. As a result of the registration, SNS 1520 may create and store information in SNS data store 1530 about the user, often referred to as a user profile. The user profile may include the user's identification information, background information, employment information, demographic information, communication channel information, personal interests, or other suitable information. Information stored by SNS 1520 for a user may be updated based upon the user's interactions with SNS 1520 and other users of SNS 1520. For example, a user may add connections to any number of other users of SNS 1520 to whom they desire to be connected. The term “friend” is sometimes used to refer to any other users of SNS 1520 to whom a user has formed a connection, association, or relationship via SNS 1520. Connections may be added explicitly by a user or may be automatically created by SNS 1520 based upon common characteristics of the users (e.g., users who are alumni of the same educational institution).

SNS 1520 may also store information in SNS data store 1530 related to the user's interactions and relationships with other concepts (e.g., users, groups, posts, pages, events, photos, audiovisual content (e.g., videos), apps, etc.) in SNS 1520. SNS 1520 may store the information in a social graph. The social graph may include nodes representing individuals, groups, organizations, or the like. The edges between the nodes may represent one or more specific types of interdependencies or interactions between the concepts. SNS 1520 may use this stored information to provide various services (e.g., wall posts, photo sharing, event organization, messaging, games, advertisements, or the like) to its users to facilitate social interaction between users using SNS 1520. In one embodiment, if users of SNS 1520 are represented as nodes in the social graph, the term “friend” may refer to an edge formed between and directly connecting two user nodes.

SNS 1520 may facilitate linkages between a variety of concepts, including users, groups, etc. These concepts may be represented by nodes of the social graph interconnected by one or more edges. A node in the social graph may represent a concept that may act on another node representing another concept and/or that may be acted on by the concept corresponding to the another node. A social graph may include various types of nodes corresponding to users, non-person concepts, content items, web pages, groups, activities, messages, and other things that may be represented by objects in SNS 1520. An edge between two nodes in the social graph may represent a particular kind of connection, or association, between the two nodes, which may result from node relationships or from an action that was performed by a concept represented by one of the nodes on a concept represented by the other node. In some cases, the edges between nodes may be weighted. In certain embodiments, the weight associated with an edge may represent an attribute associated with the edge, such as a strength of the connection or association between nodes. Different types of edges may be provided with different weights. For example, an edge created when one user “likes” another user may be given one weight, while an edge created when a user befriends another user may be given a different weight.

SNS 1520 may also store various types of content in SNS data store 1530, the content including but not limited to posts, pages, groups, events, photos, videos, apps, and other content provided by users of SNS 1520.

Distributed system 1500 depicted in FIG. 15 is merely an example and is not intended to unduly limit the scope of inventive embodiments recited in the claims. One of ordinary skill in the art would recognize many possible variations, alternatives, and modifications. For example, in some implementations, distributed system 1500 may have more or fewer systems than those shown in FIG. 15, may combine two or more systems, or may have a different configuration or arrangement of systems.

User device 1510 may sometimes be referred to as a client device, or simply a client. User device 1510 may be a computing device, such as, for example, a mobile phone, a smart phone, a personal digital assistant (PDA), a tablet computer, an electronic book (e-book) reader, a gaming console, a laptop computer, a netbook computer, a desktop computer, a thin-client device, a workstation, etc.

One or more applications (“apps”) may be hosted and executed by user device 1510. The apps may be web browser-based applications or other types of applications. In the example embodiment depicted in FIG. 15, user device 1510 hosts and executes social networking application 1512, which enables a user to interact with SNS 1520. For example, a user using user device 1510 may log into or register with SNS 1520, post content to and share content with other members of SNS 1520, access and interact with content and services provided by SNS 1520, and the like.

In the embodiment depicted in FIG. 15, SNS 1520 includes survey subsystem 1522 for sending a user survey (as depicted in FIG. 2 or FIG. 7) to and/or receiving a response to the user survey from one or more user devices (e.g., user device 1510). The user survey may enable a user to indicate a trust score for each of one or more domains, the trust score included in the response. In some examples, the user survey may also enable the user to indicate that the user does not recognize a domain.

The user survey and/or the response to the user survey from a user may be stored in survey data store 1524. In some examples, instead of the response, a pair including an identification of a user of SNS 1520 and a trust score included in the response may be stored. While FIG. 15 illustrates survey data store 1524 included in SNS 1520, it should be recognized that survey data store 1524 is remote from SNS 1520.

SNS 1520 may further include trust score determination subsystem 1526. Trust score determination subsystem 1526 may calculate a trust score when a user did not indicate a trust score for a domain. Trust score determination subsystem 1526 may also, or in the alternative, determine an overall trust score for a domain. In some examples, after the overall trust score is determined, a pairing of the overall trust score and the domain may be stored in trust score tag data store 1532. In other examples, if the overall trust score is above a threshold, a pairing of the domain and an indication whether the domain is a trusted domain may be stored in trust score tag data store 1532. While FIG. 15 illustrates trust score tag data store 1532 included in SNS 1520, it should be recognized that trust score tag data store 1532 is remote from SNS 1520. Data used by trust score determination subsystem 1526 may be included in SNS data store 1530, as described above.

SNS 1520 may further include action subsystem 1528 for performing one or more actions based upon a pairing stored in trust score tag data store 1532. In some examples, the action performed may be based on an amount of the overall trust score for the domain. For example, if the overall trust score is above a user-defined threshold, a first action may be performed; and if the overall trust score is below the user-defined threshold, a second action may be performed. In another example, there may be multiple user-defined thresholds, each user-defined threshold causing a different action to be performed if the overall trust score exceeds the user-defined threshold. In other examples, the action performed may be based on whether the domain has been determined to be a trusted domain. In such examples, if the domain has been determined to be a trusted domain, a particular action may be performed.

An example of an action includes SNS 1520 causing a label to be included with content from the domain. Based on whether the domain is indicated as trusted or untrusted, the label may indicate such. For another example, when SNS 1520 receives a request to send content to a user, action subsystem 1528 may identify content from a domain that is indicated as a trusted domain. The content from the domain may be sent to the user instead of content from a domain that has not been indicated as a trusted domain. For another example, content from a domain with a higher trust score may be sent to users instead of content from a domain with a lower trust score. Data used by action subsystem 1528 may be included in SNS data store 1530, as described above.

While the description above generally relates to domains that are surveyed, similar techniques may be used for one or more domains that have not been included in a survey. For example, an automatic propagation method may be used to infer one or more trust scores for a domain that has not been surveyed. In such an example, the automatic propagation method may be based upon domains that have been surveyed that are determined to be similar to a domain that has not been surveyed. In some examples, multiple similar domains may be used to identify a trust score for the domain that has not been surveyed.

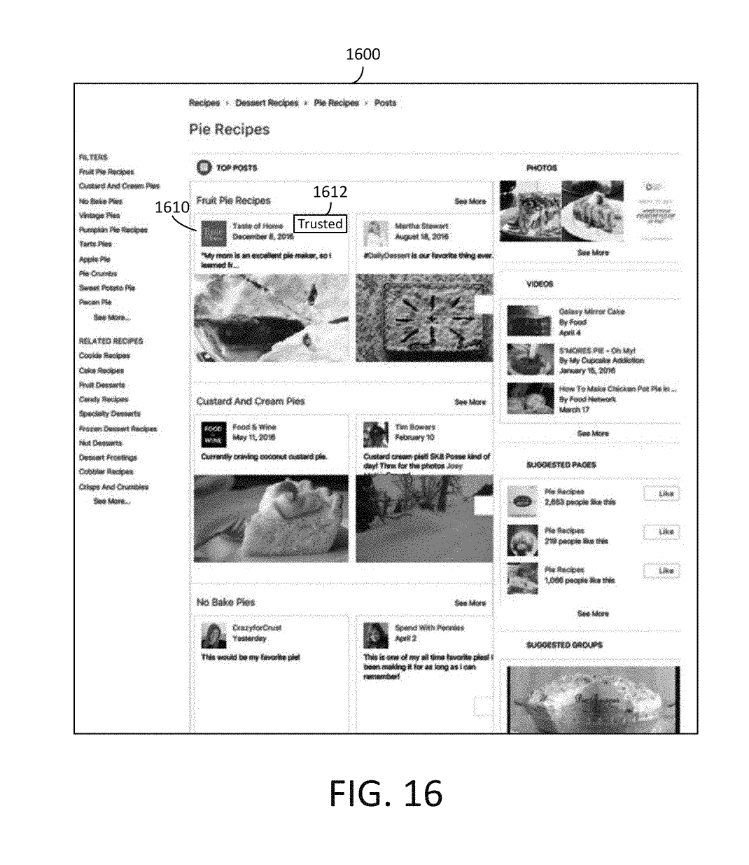

FIG. 16 depicts an example of content 1610 included on page 1600 provided by a social networking system according to certain embodiments. While page 1600 is illustrated as including content from multiple domains, page 1600 may, in some embodiments, only include content from a domain associated with content 1610. When the domain has been tagged as a trusted domain, content from the particular domain may include a label that indicates the content is from a trusted domain (as illustrated by label 1612). In some examples, a label may be attached to content that has been tagged as a untrusted domain (not illustrated).

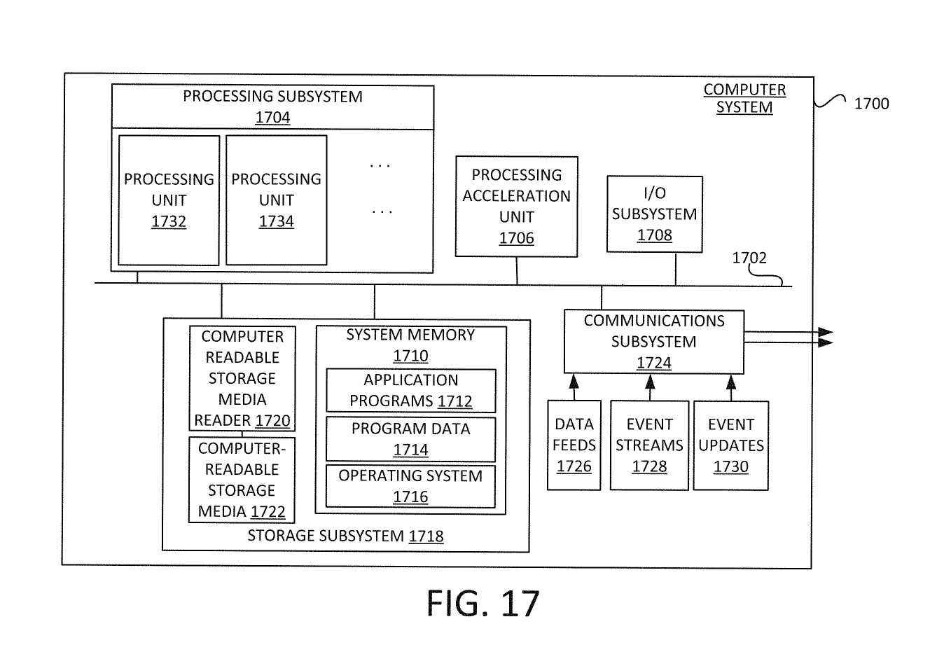

FIG. 17 depicts computer system 1700, which may be used to implement certain embodiments described herein. For example, in some embodiments, computer system 1700 may be used to implement any of the systems, servers, devices, or the like described above. As shown in FIG. 17, computer system 1700 includes various subsystems including processing subsystem 1704 that communicates with a number of other subsystems via bus subsystem 1702. These other subsystems may include processing acceleration unit 1706, I/O subsystem 1708, storage subsystem 1718, and communications subsystem 1724. Storage subsystem 1718 may include non-transitory computer-readable storage media including storage media 1722 and system memory 1710.

Bus subsystem 1702 provides a mechanism for letting the various components and subsystems of computer system 1700 communicate with each other as intended. Although bus subsystem 1702 is shown schematically as a single bus, alternative embodiments of bus subsystem 1702 may utilize multiple buses. Bus subsystem 1702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 1704 controls the operation of computer system 1700 and may comprise one or more processors, application specific integrated circuits (ASICs), or field programmable gate arrays (FPGAs). The processors may include single core and/or multicore processors. The processing resources of computer system 1700 may be organized into one or more processing units 1732, 1734, etc. A processing unit may include one or more processors, one or more cores from the same or different processors, a combination of cores and processors, or other combinations of cores and processors. In some embodiments, processing subsystem 1704 may include one or more special purpose co-processors such as graphics processors, digital signal processors (DSPs), or the like. In some embodiments, some or all of the processing units of processing subsystem 1704 may be implemented using customized circuits, such as application specific integrated circuits (ASICs), or field programmable gate arrays (FPGAs).

In some embodiments, the processing units in processing subsystem 1704 may execute instructions stored in system memory 1710 or on computer readable storage media 1722. In various embodiments, the processing units may execute a variety of programs or code instructions and may maintain multiple concurrently executing programs or processes. At any given time, some or all of the program code to be executed may be resident in system memory 1710 and/or on computer-readable storage media 1722 including potentially on one or more storage devices. Through suitable programming, processing subsystem 1704 may provide various functionalities described above. In instances where computer system 1700 is executing one or more virtual machines, one or more processing units may be allocated to each virtual machine.

In certain embodiments, processing acceleration unit 1706 may optionally be provided for performing customized processing or for off-loading some of the processing performed by processing subsystem 1704 so as to accelerate the overall processing performed by computer system 1700.

I/O subsystem 1708 may include devices and mechanisms for inputting information to computer system 1700 and/or for outputting information from or via computer system 1700. In general, use of the term input device is intended to include all possible types of devices and mechanisms for inputting information to computer system 1700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices that enable users to control and interact with an input device and/or devices that provide an interface for receiving input using gestures and spoken commands. User interface input devices may also include eye gesture recognition devices that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 1700 to a user or other computer system. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 1718 provides a repository or data store for storing information and data that is used by computer system 1700. Storage subsystem 1718 provides a tangible non-transitory computer-readable storage medium for storing the basic programming and data constructs that provide the functionality of some embodiments. Storage subsystem 1718 may store software (e.g., programs, code modules, instructions) that when executed by processing subsystem 1704 provides the functionality described above. The software may be executed by one or more processing units of processing subsystem 1704. Storage subsystem 1718 may also provide a repository for storing data used in accordance with the teachings of this disclosure.

Storage subsystem 1718 may include one or more non-transitory memory devices, including volatile and non-volatile memory devices. As shown in FIG. 17, storage subsystem 1718 includes system memory 1710 and computer-readable storage media 1722. System memory 1710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1700, such as during start-up, may typically be stored in the ROM. The RAM typically contains data and/or program modules that are presently being operated and executed by processing subsystem 1704. In some implementations, system memory 1710 may include multiple different types of memory, such as static random access memory (SRAM), dynamic random access memory (DRAM), and the like.

By way of example, and not limitation, as depicted in FIG. 17, system memory 1710 may load application programs 1712 that are being executed, which may include various applications such as Web browsers, mid-tier applications, relational database management systems (RDBMS), etc., program data 1714, and operating system 1716.

Computer-readable storage media 1722 may store programming and data constructs that provide the functionality of some embodiments. Computer-readable media 1722 may provide storage of computer-readable instructions, data structures, program modules, and other data for computer system 1700. Software (programs, code modules, instructions) that, when executed by processing subsystem 1704 provides the functionality described above, may be stored in storage subsystem 1718. By way of example, computer-readable storage media 1722 may include non-volatile memory such as a hard disk drive, a magnetic disk drive, an optical disk drive such as a CD ROM, DVD, a Blu-Ray® disk, or other optical media. Computer-readable storage media 1722 may include, but is not limited to, Zip® drives, flash memory cards, universal serial bus (USB) flash drives, secure digital (SD) cards, DVD disks, digital video tape, and the like. Computer-readable storage media 1722 may also include, solid-state drives (SSD) based upon non-volatile memory such as flash-memory based SSDs, enterprise flash drives, solid state ROM, and the like, SSDs based upon volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain embodiments, storage subsystem 1718 may also include computer-readable storage media reader 1720 that may further be connected to computer-readable storage media 1722. Reader 1720 may receive and be configured to read data from a memory device such as a disk, a flash drive, etc.

In certain embodiments, computer system 1700 may support virtualization technologies, including but not limited to virtualization of processing and memory resources. For example, computer system 1700 may provide support for executing one or more virtual machines. In certain embodiments, computer system 1700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1700. Accordingly, multiple operating systems may potentially be run concurrently by computer system 1700.

Communications subsystem 1724 provides an interface to other computer systems and networks. Communications subsystem 1724 serves as an interface for receiving data from and transmitting data to other systems from computer system 1700. For example, communications subsystem 1724 may enable computer system 1700 to establish a communication channel to one or more client devices via the Internet for receiving and sending information from and to the client devices. For example, when computer system 1700 is used to implement social networking system (SNS) 1520 depicted in FIG. 15, communication subsystem 1724 may be used to communicate with user devices (e.g., user device 1510 in FIG. 15).

Communication subsystem 1724 may support both wired and/or wireless communication protocols. For example, in certain embodiments, communications subsystem 1724 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments, communications subsystem 1724 may provide wired network connectivity (e.g., Ethernet) in addition to or instead of a wireless interface.

Communication subsystem 1724 may receive and transmit data in various forms. For example, in some embodiments, in addition to other forms, communications subsystem 1724 may receive input communications in the form of structured and/or unstructured data feeds 1726, event streams 1728, event updates 1730, and the like. For example, communications subsystem 1724 may be configured to receive (or send) data feeds 1726 in real-time from users of social media networks and/or other communication services such as web feeds and/or real-time updates from one or more third party information sources.

In certain embodiments, communications subsystem 1724 may be configured to receive data in the form of continuous data streams, which may include event streams 1728 of real-time events and/or event updates 1730, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1724 may also be configured to communicate data from computer system 1700 to other computer systems or networks. The data may be communicated in various different forms such as structured and/or unstructured data feeds 1726, event streams 1728, event updates 1730, and the like to one or more databases that may be in communication with one or more streaming data source computers coupled to computer system 1700.

Computer system 1700 may be one of various types, including a handheld portable device, a wearable device, a personal computer, a workstation, a mainframe, a kiosk, a server rack, or any other data processing system. Due to the ever-changing nature of computers and networks, the description of computer system 1700 depicted in FIG. 17 is intended only as a specific example. Many other configurations having more or fewer components than the system depicted in FIG. 17 are possible. Based on the disclosure and teachings provided herein, a person of ordinary skill in the art will appreciate other ways and/or methods to implement the various embodiments.

Some embodiments described herein make use of social networking data that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well.

In the preceding description, for the purposes of explanation, specific details are set forth in order to provide a thorough understanding of examples of the disclosure. However, it should be apparent that various examples may be practiced without these specific details. For example, circuits, systems, networks, processes, and other components may be shown as components in block diagram form in order to not obscure the examples in unnecessary detail. In other instances, well-known circuits, processes, algorithms, structures, and techniques may have been shown without necessary detail in order to avoid obscuring the examples. The figures and description are not intended to be restrictive.

The description provides examples only, and is not intended to limit the scope, applicability, or configuration of the disclosure. Rather, the description of the examples provides those skilled in the art with an enabling description for implementing an example. It should be understood that various changes may be made in the function and arrangement of elements without departing from the spirit and scope of the disclosure as set forth in the appended claims.

Also, it is noted that individual examples may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable storage medium or computer-readable storage medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements.

Furthermore, examples may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. One or more processors may execute the software, firmware, middleware, microcode, the program code, or code segments to perform the necessary tasks.

Systems depicted in some of the figures may be provided in various configurations. In some embodiments, the systems may be configured as a distributed system where one or more components of the system are distributed across one or more networks such as in a cloud computing system.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The terms and expressions that have been employed in this disclosure are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although certain concepts and techniques have been specifically disclosed, modification and variation of these concepts and techniques may be resorted to by those skilled in the art, and that such modifications and variations are considered to be within the scope of the systems and methods as defined by this disclosure.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented as a computer program product containing computer program code or instructions executable by one or more processors for performing any or all of the steps, operations, or processes described in this disclosure, where the computer program may be stored on a non-transitory computer readable medium. The various processes described herein may be implemented on the same processor or different processors in any combination.

What is claimed is:

1. A method comprising:
receiving, for a domain, trust scores provided by a plurality of users, wherein a trust score provided by a user of the plurality of users is indicative of a level of trust in the domain for the user;
calculating an overall trust score for the domain based upon the trust scores;
determining to identify the domain as a trusted domain based upon the overall trust score; and
tagging the domain as a trusted domain in a social networking system.

2. The method of claim 1 further comprising:
sending content associated with the domain to a user of the social networking system, wherein the content includes information indicating that the content is associated with a trusted domain.

3. The method of claim 1 further comprising:
sending content associated with the domain to a user of the social networking system based upon the domain being tagged as a trusted domain.

4. The method of claim 1, wherein calculating comprises:
selecting a set of trust scores from the trust scores, wherein the trust scores include at least one trust score that is not included in the set of trust scores; and
calculating the overall trust score based upon trust scores included in the set of test scores.

5. The method of claim 4, wherein each trust score of the set of trust scores has a trust score less than an average of the trust scores.

6. The method of claim 4, wherein selecting comprises:
creating an ordered list of the trust scores; and
selecting the set of trust scores based upon an ordering of the ordered list.

7. The method of claim 6, wherein the ordering is from lowest to highest, and wherein at least one lowest trust score or at least one highest trust score in the ordered list is not selected to be in the set of trust scores.

8. The method of claim 1 further comprising:
presenting a survey to a user of the plurality of users, the survey including an option for the user to select a trust score from a set of trust scores for the domain, wherein the selected trust score is included in the trust scores.

9. A method comprising:
receiving, for a domain, trust scores provided by a first set of users of a plurality of users, wherein a trust score provided by a user of the first set of users is indicative of a level of trust in the domain for the user;
computing a trust score for each user of a second set of users of the plurality of users;
calculating an overall trust score for the domain based upon the trust scores provided by the first set of users and the trust scores computed for the second set of users;
determining to identify the domain as a trusted domain based upon the overall trust score; and
tagging the domain as a trusted domain in a social networking system.

10. The method of claim 9 further comprising:
sending content associated with the domain to a user of the social networking system, wherein the content includes information indicating that the content is associated with a trusted domain.

11. The method of claim 9 further comprising:
sending content associated with the domain to a user of the social networking system based upon the domain being tagged as a trusted domain.

12. The method of claim 9, wherein calculating comprises:
selecting a set of users from the plurality of users, wherein the plurality of users include at least one user that is not included in the set of users; and
calculating the overall trust score based upon trust scores of the users included in the set of users.

13. The method of claim 12, wherein selecting comprises:
creating an ordered list of the trust scores provided by the first set of users and the trust scores computed for the second set of users; and
selecting the set of trust scores based upon an ordering of the ordered list.

14. The method of claim 13, wherein the ordering is from lowest to highest, and wherein at least one lowest trust score or at least one highest trust score in the ordered list are not selected to be in the set of trust scores.

15. The method of claim 9 further comprising:
presenting a survey to a user of the plurality of users, the survey including an option for the user to identify whether the user recognizes the domain and, if the user recognizes the domain, to select a trust score from a set of trust scores for the domain.

16. The method of claim 9, wherein computing the trust score for the user comprises:
averaging a trust score for one or more users other than the user.

17. The method of claim 9, further comprising:
for each user of the plurality of users, generating a multi-dimensional vector for the user based upon one or more interactions of the user within the social networking system; and
generating clusters of one or more users from the plurality of users based upon multi-dimensional vectors for each user of the plurality of users.

18. The method of claim 17 further comprising:
identifying one or more clusters of the clusters, the one or more clusters including at least one user that does not recognize the domain; and
for each cluster of the one or more clusters:
identifying one or more users that do not recognize the domain; and
for each user of the one or more users, computing a trust score for the user based upon trust scores for one or more other users in the cluster.

19. The method of claim 17 further comprising:
for each cluster of the clusters, calculating a cluster trust score for the domain based upon trust scores for users in the cluster;
creating an ordered list of the clusters based upon the cluster trust scores;
selecting a set of clusters from the clusters, wherein the clusters include at least one cluster that is not included in the set of clusters; and
calculating the overall trust score based upon cluster trust scores included in the set of clusters.

20. A non-transitory computer-readable storage medium storing a plurality of instructions executable by one or more processors, the plurality of instructions when executed by the one or more processors cause the one or more processors to:
receive, for a domain, trust scores provided by a plurality of users, wherein a trust score provided by a user of the plurality of users is indicative of a level of trust in the domain for the user;
calculate an overall trust score for the domain based upon the trust scores;
determine to identify the domain as a trusted domain based upon the overall trust score; and
tag the domain as a trusted domain in a social networking system.
